(19) United States
(12) Patent Application Publication
(10) Pub. No.: US 2020/0030651 A1
(43) Pub. Date: Jan. 30, 2020

(54) VIRTUAL REALITY FIRE-FIGHTING EXPERIENCE SYSTEM

(71) Applicant: MWN TECH. CO, LTD, Anyang-si (KR)

(72) Inventor: Yun Kyu CHOI, Seoul (KR)

(21) Appl. No.: 15/737,289

(22) PCT Filed: Apr. 1, 2016
(86) PCT No.: PCT/KR2016/003408

§ 371 Date: Dec. 17, 2017

(30) Foreign Application Priority Data
Jan. 28, 2016 (KR) 10-2016-0010925

(51) Int. Cl. A62C 99/00; G09B 9/00; G06F 1/16; G06F 3/01; G06F 3/0346; G06F 3/023

(52) U.S. Cl. CPC A62C 99/0081; G09B 9/00; G06F 1/163; G06F 3/0482; G06F 3/0346; G06F 3/023; G06F 3/012

(57) ABSTRACT

The present invention relates to a virtual reality firefighting experiential system enabling a user to calmly and swiftly handle fire upon an outbreak of the fire by configuring a fire outbreak situation as virtual reality such that the user experiences a fire suppression process under each condition through recognition of a user's behavior, which enables that no loss of lives occurs in training and the user may safely experience the fire suppression process in a similar environment to a fire scene.

### BACKGROUND

The present disclosure provides a virtual reality firefighting experiential system, and more particularly, to a virtual reality firefighting experiential system enabling a user to calmly and swiftly handle fire upon an outbreak of the fire by configuring a fire outbreak situation as virtual reality such that the user experiences a fire suppression process under each condition through recognition of a user's behavior, which enables that no loss of lives occurs in training and the user may safely experience the fire suppression process in a similar environment to a fire scene.

Typically, a firefighting training is performed to effectively avoid an accident that may happen under fire and also suppress the fire. Evacuation training and firefighting training, etc., are repetitively performed in advance, and thus the fire may be effectively suppressed at an actual fire scene.

Since a little elementary schoolchild or a preschool child lacks knowledge and experience for various fire accidents and lacks abilities to cope with a fire accident that may occur in daily life, no little damage according thereto occurs. Accordingly, an educational institution such as a school or kindergarten installs a fire extinguisher in order to conduct various kinds of education for training fire suppression or performing evacuation training such that students experience and are fully aware of firefighting.

However, in most cases, education such as the above-described firefighting training is performed in an environment apart from an actual fire environment and only fragmentary knowledge is learned, and thus, active training lacks and there is difficulty in swift handling of fire upon an outbreak of the fire.

In order to address the above-described difficulty, Korean Patent Application Publication No. 10-2011-0128454 (hereinafter, ‘Disclosed patent’) discloses “Firefighting safety experiential system and device”, which displays a fire image on a display unit and enables a user to experience firefighting training in a similar environment to an actual fire scene.

The disclosed patent relates to a firefighting safety experiential system configured from a body unit and a fire extinguisher 2, through which children experience, in a simulation, a firefighting safety accident that the children may encounter. The disclosed patent is characterized by including: a fire image output step in which a fire image is output onto a screen 11 arranged in a front side of the body 1; a smoke fuming step in which smoke 22 is fumed out through the fire extinguisher 2 to the screen 11 on which the fire image is output; a fire suppression step for informing fire suppression through a smoke sensor 14 which is arranged in one side of the body 1 and senses the fumed smoke 22 near the screen 11; a smoke suction step for operating a blast fan 12 to remove the smoke 22 near the body 1 in a state where the fire is suppressed; and a smoke removal step for removing the sucked smoke 22 through a filter 13.

However, in the above described patent, smoke of the fire extinguisher 2 is fumed onto the screen 11 on which a fire image is output, and when the smoke approaches the screen 11, fire suppression is informed through the smoke sensor 14. In other word, it is not possible for a user to train behavioral know-how under various fire outbreak conditions and thus it is difficult to swiftly handle the fire upon an actual outbreak of fire.

### SUMMARY

The present disclosure provides a virtual reality firefighting experiential system enabling a user to calmly and swiftly handle fire upon an outbreak of the fire by configuring a fire outbreak situation as virtual reality such that the user experiences a fire suppression process under each condition through recognition of a user's behavior, which enables that no loss of lives occurs in training and the user may safely experience the fire suppression process in a similar environment to a fire scene.

In accordance with an exemplary embodiment of the present invention, a virtual reality firefighting experiential system includes: a head mounted display configured to output a menu for each firefighting training situation and a picture for each virtual fire situation; a main camera configured to trace a position of the head mounted display; a controller configured to proceed fire suppression according to a fire situation on the picture displayed on the head mounted display; a holder configured to hold the controller and provided with a reset button so as to correct an initial direction and position of the controller at a time of holding the controller; a control device configured to output the menu for each firefighting training situation and the picture for each virtual fire situation to the head mounted display and connectedly installed with the controller to control a picture output to the head mounted display according to an input signal from the controller; and an auxiliary camera configured to trace the position and direction of the controller.

In accordance with another exemplary embodiment of the present invention, a virtual reality firefighting experiential system includes: a display unit configured to output a menu for each firefighting training situation and a picture for each virtual fire situation; a controller configured to proceed fire suppression according to a fire situation on the picture displayed through the display unit; a holder configured to hold the controller and provided with a reset button so as to correct an initial direction and position of the controller at a time of holding the controller; a control device configured to output the menu for each firefighting training situation and the picture for each virtual fire situation to the display unit and connectedly installed with the controller to control a picture output to the display unit according to an input signal from the controller; and an auxiliary camera configured to trace the position and direction of the controller.

In an embodiment, the controller may be composed in a nozzle type and include: a nozzle body with a prescribed length graspable by a user; a rotator rotatably coupled to a front of the nozzle body; a marker configured to guide the auxiliary camera to trace the direction and position of the controller; a rotation sensor configured to sense the rotation of the rotator and deliver a sensed result to a micro control unit (MCU); a vibration motor configured to generate a vibration such that a vibration or an impact by water pressure is felt at a time of shooting water to the picture for each virtual fire situation through manipulation of the controller; a water pressure control lever configured to control pressure of water shot to the picture for each virtual fire situation; a lever position sensor configured to sense a position of the water pressure lever and deliver a sensed result to the MCU; a motion sensor configured to sense a motion of the controller and deliver a sensed result to the MCU; a manipulation button unit configured to deliver, to the MCU, a direction input and selection input from the user; a communication means configured to communicate with the control device through wired or wireless communication; and the MCU configured to deliver, to the control device, a sensor input value from the rotation sensor, the lever position sensor, or the motion sensor, and an input value of the manipulation button unit.

In an embodiment, the controller may be composed in an extinguisher type, and include: an extinguisher body; a nozzle part coupled to an upper part of the extinguisher body to shoot content to the picture for each virtual fire situation, and composed of a marker configured to guide the auxiliary camera to trace the position and direction of the controller, and a motion sensor configured to sense a motion of the controller and deliver a sensed result to the MCU; and a shoot operation part composed of a barometer configured to indicate a virtual atmospheric pressure state, a driving unit controlled by the MCU and configured to move a needle of the barometer, a shooting lever configured to control a shoot of the content through the nozzle part, a safety pin configured to block manipulation of the shooting lever, a safety pin sensor configured to sense whether the safety pin is pinned and a manipulation state of the shooting lever and to deliver a sensed result and the manipulation state to the MCU, a communication means configured to communicate with the control device through wired or wireless communication, and the MCU configured to deliver input values from the motion sensor and the safety pin sensor to the control device 500.

In an embodiment, correction of the controller may be performed by matching up a preset reference direction, a recognition direction recognized by the control device, and an actual direction of the controller with each other, and the matching up is performed with any one of a scheme for resetting, in a state where the direction of the controller is matched up with the preset reference direction, to a state where the reference direction, recognition direction, and actual direction are matched up with each other by manipulating a button of the controller, a scheme for resetting to a state where reference direction, recognition direction, and actual direction are matched up with each other according to manipulation of the reset button for correcting the initial direction and position of the controller at a time of holding the controller, and a scheme for guiding the controller to face the reference direction through a user's guide at a time of starting each step on a program installed in the control device, and then resetting to a state where the reference direction, recognition direction, and actual direction are matched up.

### BRIEF DESCRIPTION OF THE DRAWINGS

Exemplary embodiments can be understood in more detail from the following description taken in conjunction with the accompanying drawings, in which:

FIG. 1 illustrates a configuration of a virtual reality firefighting experiential system according to an embodiment of the present disclosure;

FIGS. 2 and 3 illustrate a configuration of a nozzle type controller in a virtual reality firefighting experiential system according to an embodiment of the present disclosure;

FIGS. 4 and 5 are explanatory diagrams showing a kitchen fire suppression training process of a virtual reality firefighting experiential system according to an embodiment of the present disclosure;

FIGS. 6 and 7 are explanatory diagrams showing an apartment fire suppression training process of a virtual reality firefighting experiential system according to an embodiment of the present disclosure;

FIGS. 8 to 10 are explanatory diagrams showing an apartment fire evacuation training process of a virtual reality firefighting experiential system according to an embodiment of the present disclosure;

FIGS. 11 to 13 are explanatory diagrams showing a subway fire evacuation training process of a virtual reality firefighting experiential system according to an embodiment of the present disclosure;

FIG. 14 is a configuration of a virtual reality firefighting experiential system according to another embodiment of the present disclosure;

FIG. 15 is a configuration of an extinguisher type controller of a virtual reality firefighting experiential system according to an embodiment of the present disclosure; and

FIG. 16 is a configuration of a throwing extinguisher type controller of a virtual reality firefighting experiential system according to another embodiment of the present disclosure.

### DETAILED DESCRIPTION OF EMBODIMENTS

Hereinafter, the present disclosure will be described in detail with the accompanying drawings. Like reference numerals in the drawings denote like elements.

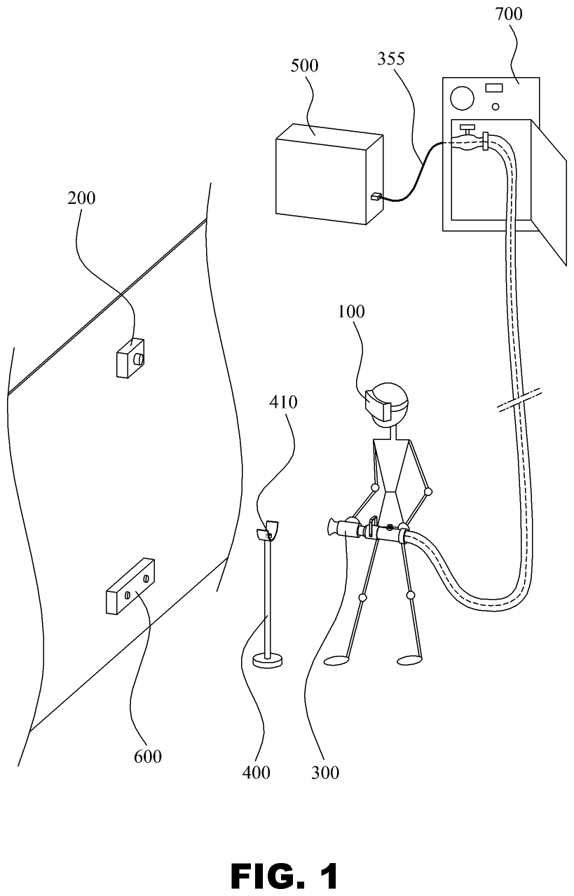

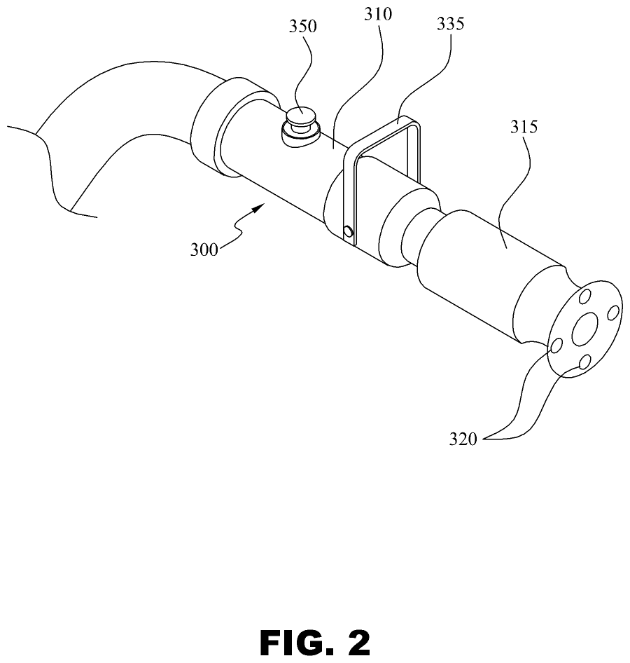

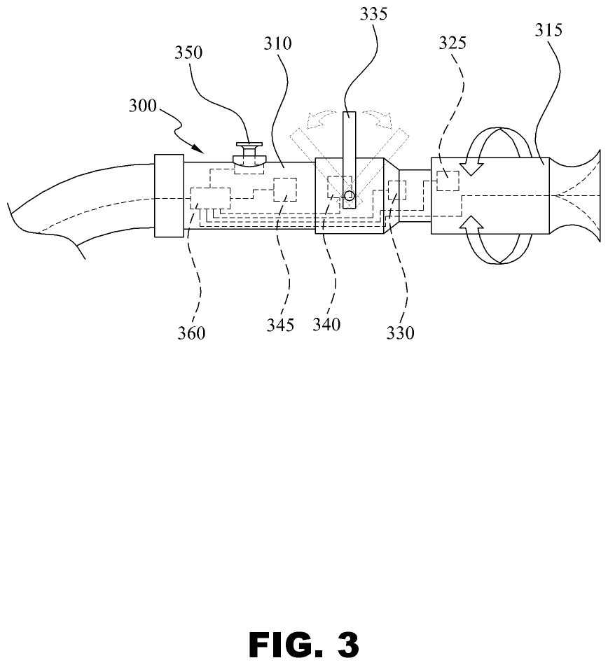

FIG. 1 illustrates a configuration of a virtual reality firefighting experiential system according to an embodiment of the present disclosure, and FIGS. 2 and 3 are configurations of a nozzle type controller of a virtual reality firefighting experiential system according to an embodiment of the present disclosure.

Referring to FIGS. 1 to 3, a virtual reality firefighting experiential system according to an embodiment of the present disclosure includes a head mounted display (HMD) 100, a main camera 200, a controller 300, a holder 400, a control device 500, and an auxiliary camera 600.

The HMD 100 is worn on the user's head and a menu for each firefighting training situation and a picture for each virtual fire situation are output thereon. A stereoscopic image, which is provided from the control device 500 such that the user can perform a fire suppression training or evacuation training, is provided onto the HMD 100 and a marker may be provided therewith such that it is easy to trace a location through the main camera 200 to be described below.

In the technical field to which the present disclosure belongs, the HMD 100 is well known, and thus a detailed description thereabout will be omitted.

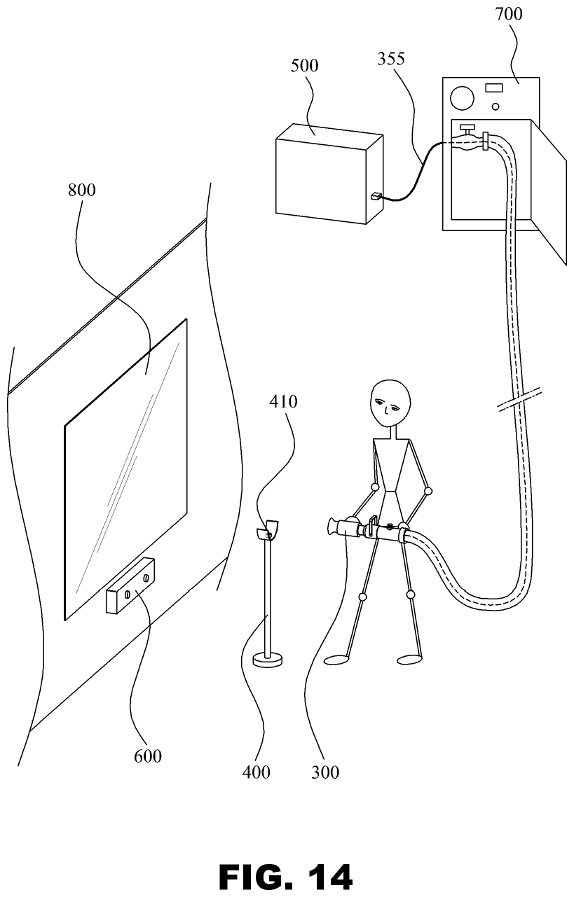

On the other hand, as illustrated in FIG. 14, in replacement of the HMD 100, it is possible to compose such that the menu for each firefighting training situation and the picture for each virtual fire situation are output through a display unit 800 arranged in the front of the user.

The main camera 200 captures a stereoscopic image of the user and traces the location of the HMD 100. The main camera 200 may recognize the marker provided to the HMD 100 and check whether a posture of the user is correct at the time of evacuation and feed the checked result back.

For example, the height of the head location is recognized through recognition of the marker of the HMD 100, and when the head height is greater than a reference value, a message is displayed on the screen with a warning sound of bending down.

The controller 300 proceeds a fire suppression process according to the fire situation displayed on the screen through the HMD 100, and may be formed in a nozzle type, an extinguisher type, or a throwing extinguisher type.

First, the nozzle type controller is composed of a nozzle body 310 formed in a prescribed length that the user may grasp, a rotator 315 rotatably coupled to the front of the nozzle body 310, a marker 320 configured to guide the auxiliary camera 600 to trace a location and direction of the controller 300, a rotation sensor 325 configured to sense rotation of the rotator 315 and deliver the sensed result to the micro control unit (MCU) 360, a vibration motor 330 configured to generate a vibration such that the vibration or an impact caused by water pressure may be sensed at the time of shooting water to the picture for each virtual fire situation through manipulation of the controller 300, a water pressure adjusting lever 335 configured to adjust the water pressure of the water shot onto the picture for each virtual fire situation, a lever position sensor 340 configured to sense a position of the water pressure control lever 335 to deliver the sensed position to the MCU 360, a motion sensor 345 configured to sense a motion of the controller 300 to deliver the sensed motion to the MCU 360, a manipulation button unit 350 configured to deliver a direction input and a selection input by the user to the MCU 360, a communication means 355 configured to communicate with the control device 500 through wired or wireless communication, the MCU 360 configured to deliver, to the control device 500, a sensor input value from the rotation sensor 325, the lever position sensor 340, or the motion sensor 345, or an input value of the manipulation button unit 350.

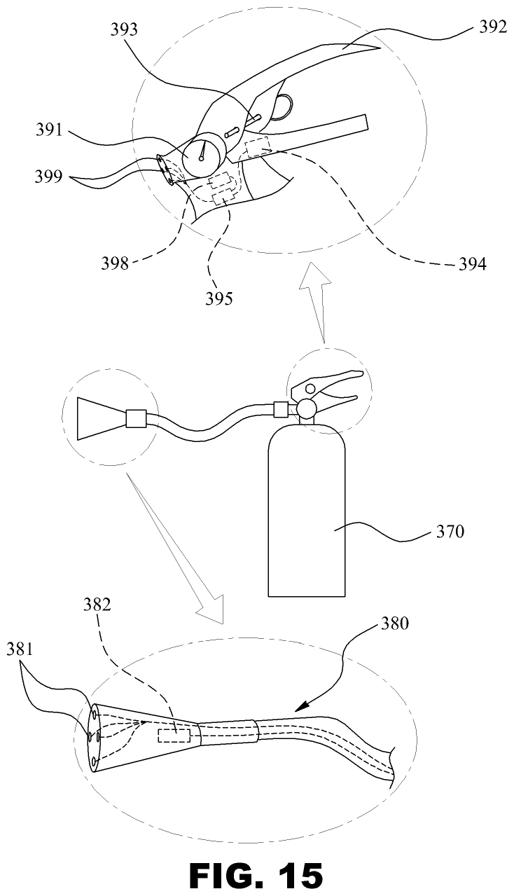

On the other hand, as illustrated in FIG. 15, the extinguisher type controller is composed of an extinguisher body 370, a nozzle part 380 configured to shoot content, and a shooting operation unit 390 configured to control shooting through the nozzle part 380, where the nozzle part 380 is coupled to an upper part of the extinguisher body 370 to shoot the content to the picture for each virtual fire situation and is composed of: a marker 381 configured to guide the auxiliary camera 600 to trace the position and direction of the controller 300; and a motion sensor 382 configured to sense a motion of the controller 300 and deliver the motion to the MCU 395, the shoot operation part 390 is composed of: a barometer 391 configured to display a virtual atmospheric pressure state; a driving unit (not shown) controlled by the MCU 395 to move a needle of the barometer 391; a shooting lever 392 configured to control a shoot of the content through the nozzle part 380; a safety pin 393 configured to block manipulation of the shooting lever 392; a safety pin sensor 394 configured to sense whether the safety pin 393 is pinned and a manipulation state of the shooting lever 392, and deliver the sensed result and the manipulation state to the MCU 395; a communication means (not shown) configured to communicate with the control device 500 through wired or wireless communication; and the MCU 395 configured to deliver input values from the motion sensor 382 and the safety pin sensor 394 to the control device 500.

The extinguisher type controller composed as the foregoing may be configured to be able to respectively trace the positions and directions of the nozzle part 380 and the shooting operation unit 390, and in this case, the nozzle part 380 and the shooting operation unit 390 are respectively provided with makers 381 and 399 and the motion sensors 382 and 399.

When the positions and directions of the nozzle part 380 and the shooting operation unit 390 are respectively traced, the marker 381 provided to the nozzle part 380 is used for tracing the position and direction of the nozzle part 380, and the maker 399 provided to the shooting operation unit 390 is used for tracing the position and direction of the shooting operation unit 390.

In addition, the motion sensor 382 provided to the nozzle part 380 is used for sensing the motion of the nozzle part 380, and the motion sensor 398 provided to the shooting operation unit 390 is used for sensing the motion of the shooting operation unit 390.

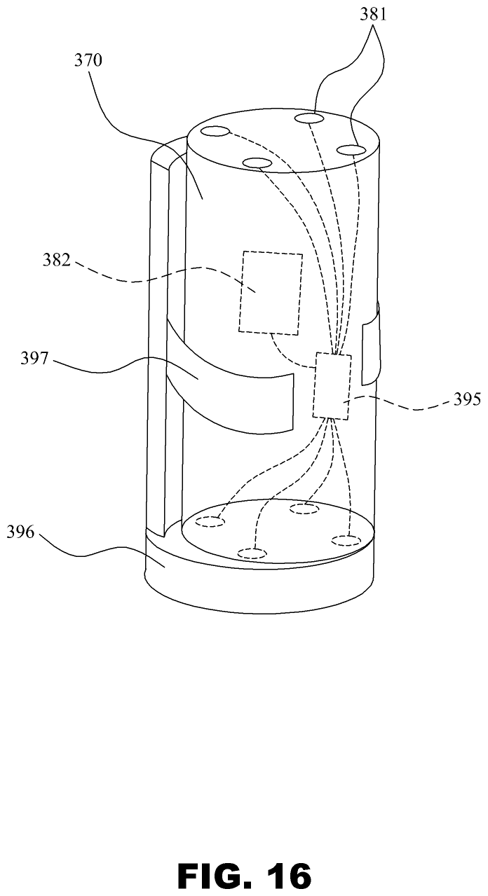

As illustrated in FIG. 16, the throwing extinguisher type controller is composed of an extinguisher body 370 having about the size that the user may grasp and throw, the maker 381 located at upper and lower ends of the extinguisher body 370 to guide the auxiliary camera 600 to be able to trace the position and direction of the controller 300, the motion sensor 382 configured to sense the motion of the controller 300 to deliver the motion to the MCU 395, a communication means (not shown) configured to communicate with the control device 500 through wired or wireless communication, the MCU 395 configured to deliver a sensor input value from the motion sensor 382 to the control device 500, a prop 396 configured to support the lower end of the extinguisher body 370, and a supporting part 397 configured to fix the extinguisher body 370 to be positioned in a state of being supported by the prop 396.

The holder 400 holds the controller 300 and may be provided with a reset button 410 so as to correct an initial position and direction of the controller 300.

The holder 400 provides directivity such that the controller 300 faces the front in a held state, and the control device 500 may set, as a reference direction, the state where the controller 300 is held by the holder 400 and correct the position, direction, or etc., of the controller 300.

The controller 500 outputs the menu for each firefighting training situation and the picture for each virtual fire situation onto the HMD 100 and is connected to the controller 300 through the communication means 355 to control the picture output on the HMD 100 according to an input signal from the controller 300. In the present disclosure, the controller 500 is characterized by proceeding a correcting operation for the initial position and direction of the controller 300.

Since not having information about an absolute position and angle value, the motion sensor 345 provided in the controller 300 may transmit, to the control device 500, an inaccurate position and angle value in which error values are accumulated. Accordingly, there may occur differences between an actual direction and position of the controller 300 and a direction and position recognized by the control device 500, and thus correction for the controller 300 may be performed by matching up a recognized direction of the controller 300, which is recognized by the control device 500, with the actual direction of the controller 300.

The correction for the controller 300 by means of the control device 500 may be performed as the following schemes. First, in a state where the direction of the controller 300 is matched up with a preset reference direction, the manipulation button unit 350 of the controller 300 is manipulated to reset to a state where the reference direction, recognized direction, and actual direction are matched up with each other. Second, at the time of holding the controller 300 with the holder 400, as the reset button 410, which corrects the initial direction and position of the controller 300, is manipulated, a reset is performed to a state where the reference direction, recognized direction, and actual direction are matched up with each other. Finally, on a program installed in the control device, at the time of starting each step, the controller 300 is guided to face the reference direction through a user's guide, and then a reset is performed to match up the reference direction, recognized direction, and actual direction with each other.

On the other hand, a relative position of the controller 300 with respect to a position of the auxiliary camera 600, which is known in advance, may be obtained by recognizing the marker 320 of the controller 300 by means of the auxiliary camera 600, and it is also possible to correct the direction recognized by the control device 500 by using the relative position.

The control device 500 may recognize the marker 320 provided in the controller 300 by processing an image acquired through the auxiliary camera 500 by means of a software library such as OpenCV or ARTool kit, and accordingly, a rotation and position of the controller 300 may be estimated. When an operation of a maker or a behavior of a user is recognized by using multiple cameras, one marker may be used as a reference point to obtain a relative position and direction among the cameras.

When using a software library such as OpenCV, a relative position and angle of a camera with respect to a designated marker may be obtained, positions and rotation states of the multiple cameras with respect to one reference marker may be obtained by using the relative position and angle, and positions of other markers may be estimated in more detail.

The auxiliary camera 600 is for tracing the position and direction of the controller 300, and may be configured from a general or 3D camera. The auxiliary camera 600 enables the control device 500 to trace the operation of the controller 300 by using the marker 320 of the controller 300.

On the other hand, the firefighting system of the present disclosure is provided with a fire hydrant 700 including an alarm bell, a firefighting hose, and a water pressure valve, etc., so as to give feelings like an actual fire scene.

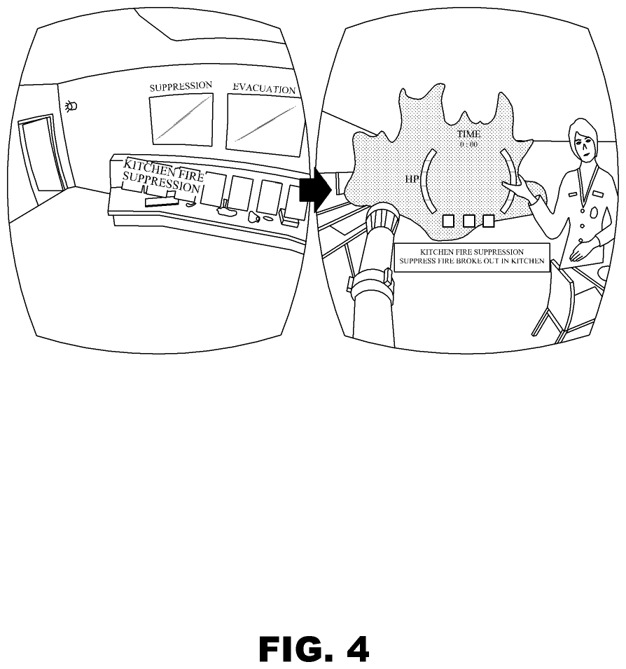

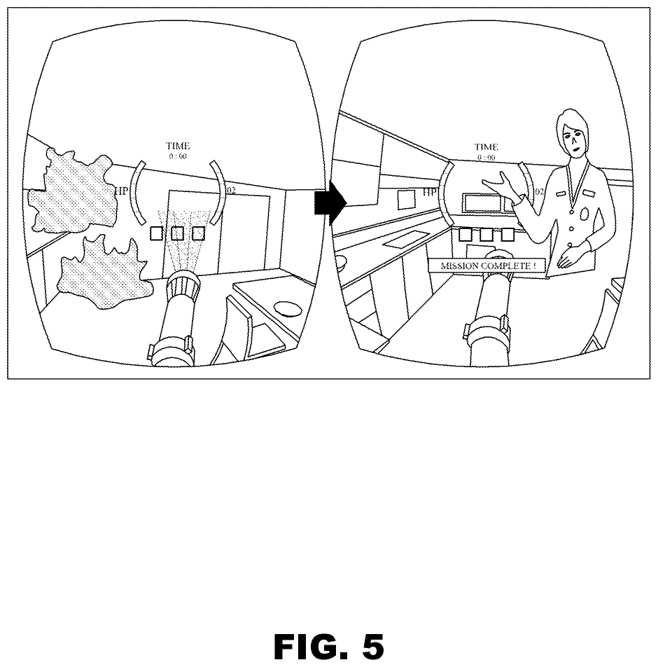

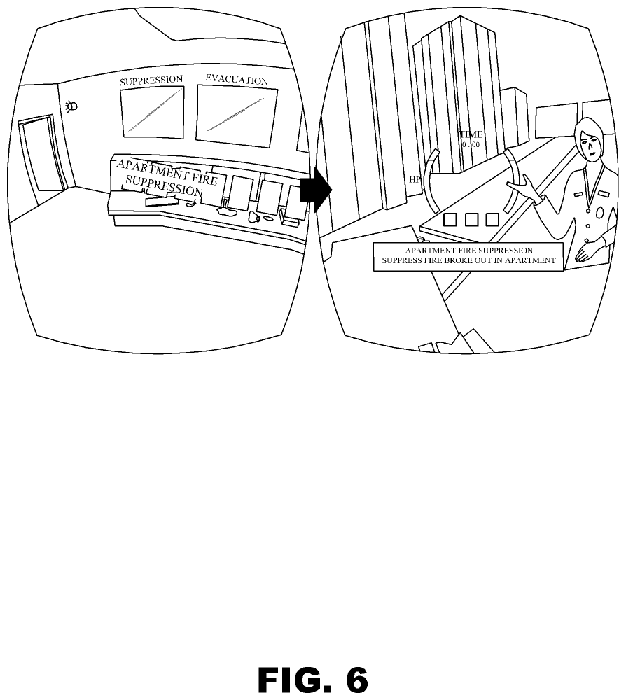

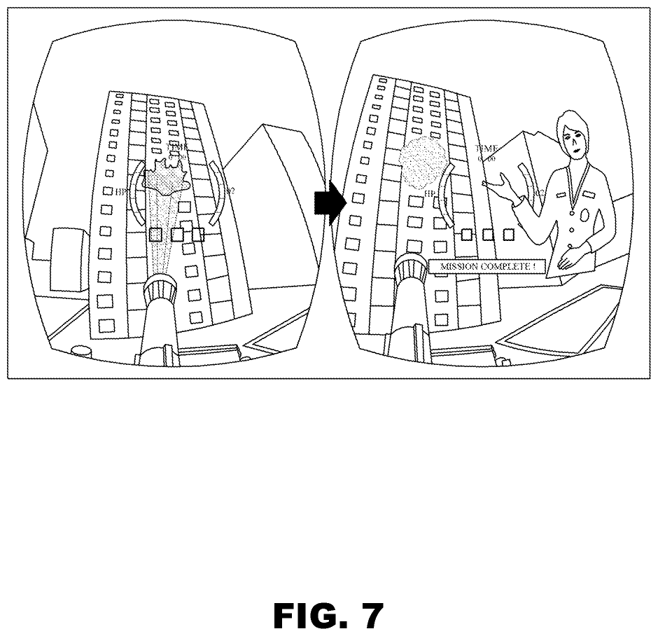

Hereinafter, a fire suppression training process of a virtual reality firefighting experiential system according to an embodiment of the present disclosure will be described in relation to FIGS. 4 and 7. Referring to FIGS. 4 to 7, when a kitchen fire suppression or an apartment fire suppression is selected in a menu picture on which suppression and evacuation, etc., are displayed, a fire suppression training for a user-selecting-site starts, and a time for completing a fire suppression mission is displayed with a guide speech or message such as “suppress a fire broke out at xx”. Then the user proceeds the fire suppression training through manipulation of the controller 300.

At this point, the user may proceed the fire suppression training by moving the controller 300 to a fire broke out area, and then manipulating the water pressure control lever 335, and when the fire suppression is completed, a guide speech or message ‘mission complete’ is output.

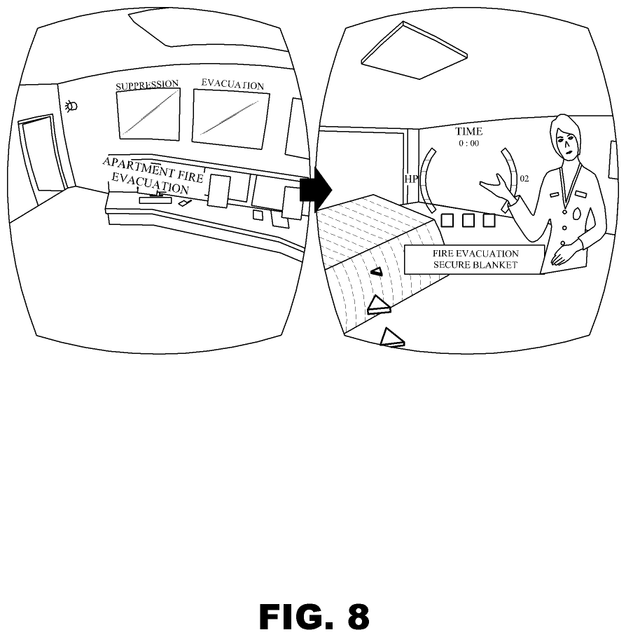

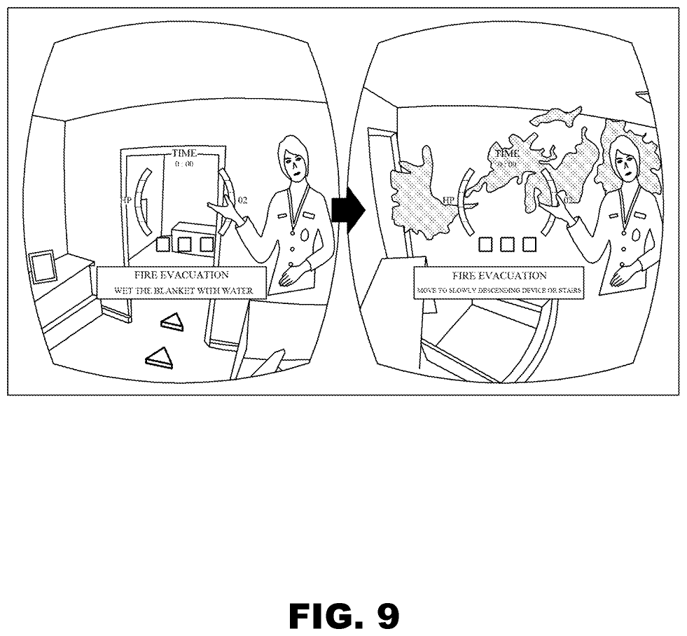

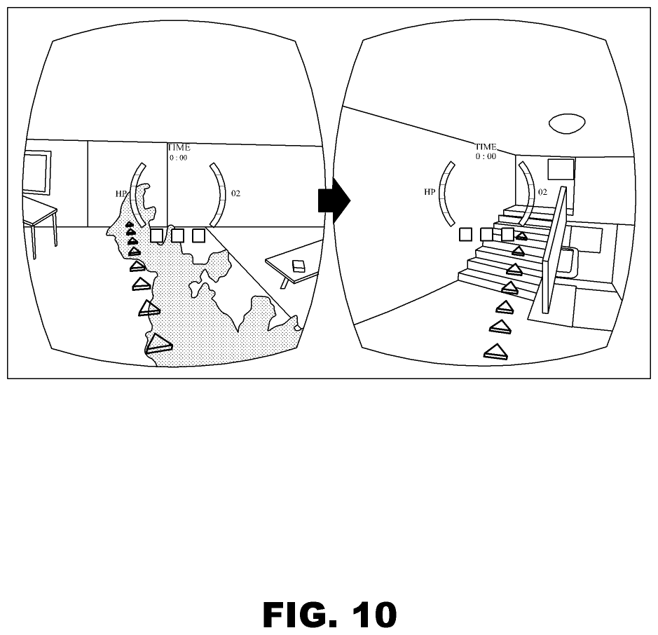

Hereinafter, an apartment fire evacuation training process of a virtual reality firefighting experiential system according to an embodiment of the present disclosure will be described in relation to FIGS. 8 and 10. Referring to FIGS. 8 to 10, when an apartment fire evacuation is selected in the menu picture on which suppression and evacuation, etc., are displayed, an evacuation training starts through which the user may be well aware of an evacuation know-how upon a fire outbreak in an apartment, and guide speeches or messages “secure a blanket”->“wet the blanket with water”->“move to a slowly descending device or stairs” are sequentially output. At this point, an indicator for guiding a user's moving direction is output together to guide a user's movement, and when the evacuation is completed, a guide speech ‘mission complete’ or message is output.

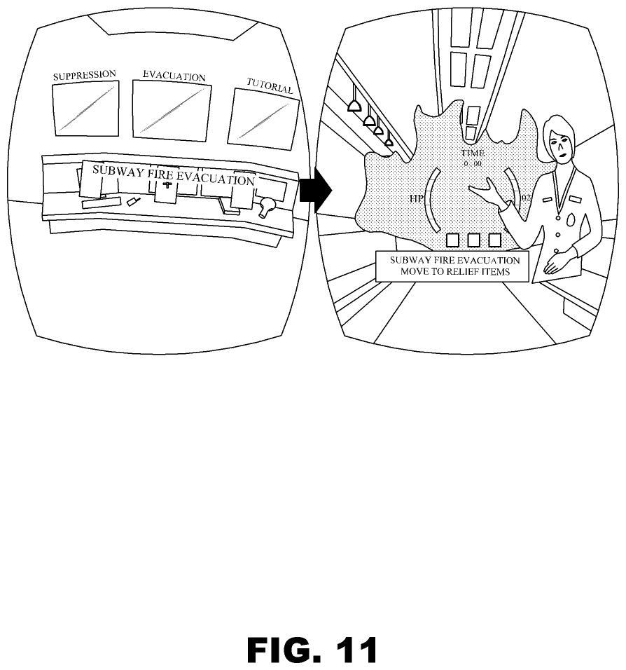

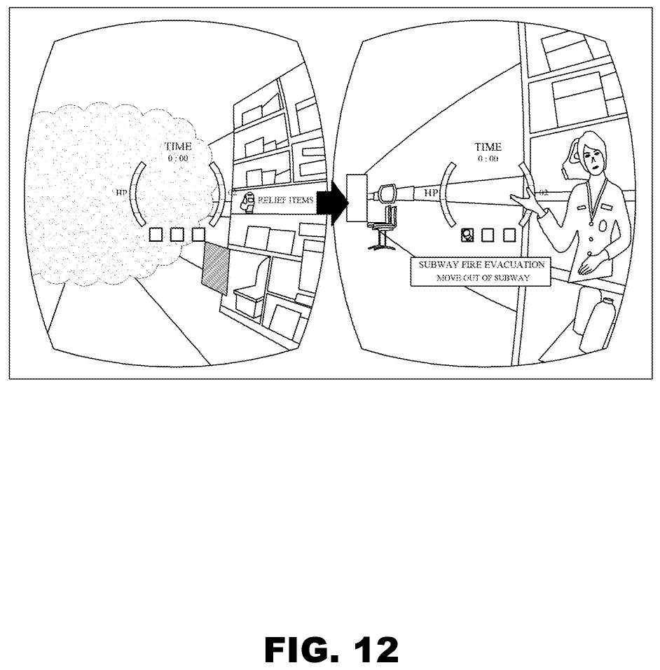

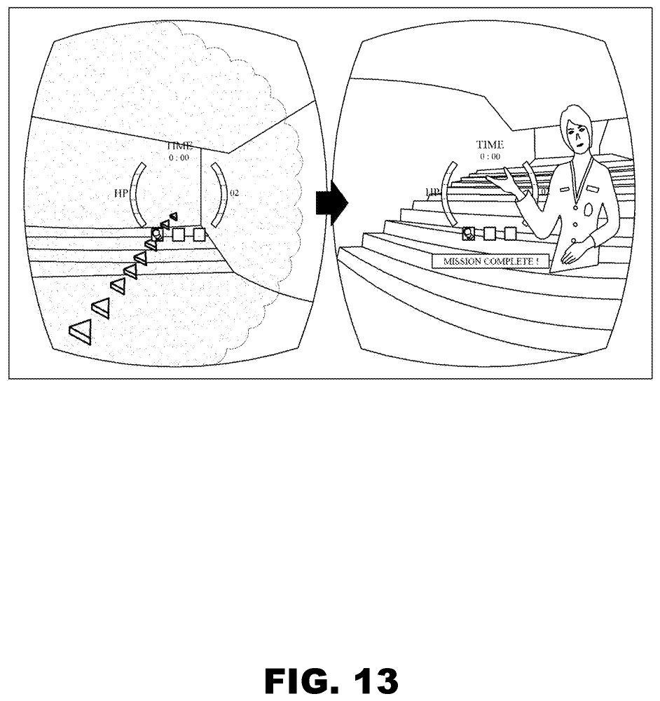

Hereinafter, a subway fire evacuation training process of a virtual reality firefighting experiential system according to an embodiment of the present disclosure will be described in relation to FIGS. 11 and 13. Referring to FIGS. 11 to 13, when a subway fire evacuation is selected on the menu picture on which suppression and evacuation, etc., are displayed, an evacuation training starts through which the user may be well aware of an evacuation know-how upon a fire outbreak in the subway, and guide speeches or messages “move to relief items”->“move out of the subway” are sequentially output. At this point, an indicator for guiding a user's moving direction is output together to guide a user's movement, and when the evacuation is completed, a guide speech ‘mission complete’ or message is output.

At the time of the evacuation training, as described above, a marker provided in the HMD 100 is recognized from an image captured by the main camera 200 and whether an evacuation posture is correct is checked and the checked result is fed back. For example, when the height of the head position is recognized by the HMD 100 through the marker recognition and the head height is higher than a reference value, a message of informing the user to bend down at the time of fire evacuation is displayed on the picture with a warning sound.

According to embodiments of the present disclosure, a user may calmly and swiftly handle fire upon an outbreak of the fire by configuring a fire outbreak situation as virtual reality such that the user experiences a fire suppression process under each condition through recognition of a user's behavior, which enables that no loss of lives occurs in training and the user may safely experience the fire suppression process in a similar environment to a fire scene.

The exemplary embodiments are disclosed in the drawings and the specification. Herein, specific terms have been used, but are just used for the purpose of describing the inventive concept and are not used for defining the meaning or limiting the scope of the inventive concept, which is disclosed in the appended claims. Thus it would be appreciated by those skilled in the art that various modifications and other equivalent embodiments can be made. Therefore, the true technical scope of the inventive concept shall be defined by the technical spirit of the appended claims.

1. A virtual reality firefighting experiential system comprising:
a head mounted display configured to output a menu for each firefighting training situation and a picture for each virtual fire situation;
a main camera configured to trace a position of the head mounted display;
a controller configured to proceed fire suppression according to a fire situation on the picture displayed on the head mounted display;
a holder configured to hold the controller and provided with a reset button so as to correct an initial direction and position of the controller at a time of holding the controller;
a control device configured to output the menu for each firefighting training situation and the picture for each virtual fire situation to the head mounted display and connectedly installed with the controller to control a picture output to the head mounted display according to an input signal from the controller; and
an auxiliary camera configured to trace the position and direction of the controller.

2. A virtual reality firefighting experiential system comprising:
a display unit configured to output a menu for each firefighting training situation and a picture for each virtual fire situation;
a controller configured to proceed fire suppression according to a fire situation on the picture displayed through the display unit;
a holder configured to hold the controller and provided with a reset button so as to correct an initial direction and position of the controller at a time of holding the controller;
a control device configured to output the menu for each firefighting training situation and the picture for each virtual fire situation to the display unit and connectedly installed with the controller to control a picture output to the display unit according to an input signal from the controller; and
an auxiliary camera configured to trace the position and direction of the controller.

3. The virtual reality firefighting experiential system of claim 1, wherein controller is composed in a nozzle type and comprises:
a nozzle body with a prescribed length graspable by a user;
a rotator rotatably coupled to a front of the nozzle body;
a marker configured to guide the auxiliary camera to trace the direction and position of the controller;
a rotation sensor configured to sense the rotation of the rotator and deliver a sensed result to a micro control unit (MCU);
a vibration motor configured to generate a vibration such that a vibration or an impact by water pressure is felt at a time of shooting water to the picture for each virtual fire situation through manipulation of the controller;
a water pressure control lever configured to control pressure of water shot to the picture for each virtual fire situation;
a lever position sensor configured to sense a position of the water pressure lever and deliver a sensed result to the MCU;
a motion sensor configured to sense a motion of the controller and deliver a sensed result to the MCU;
a manipulation button unit configured to deliver, to the MCU, a direction input and selection input from the user;
a communication means configured to communicate with the control device through wired or wireless communication; and
the MCU configured to deliver, to the control device, a sensor input value from the rotation sensor, the lever position sensor, or the motion sensor, and an input value of the manipulation button unit.

4. The virtual reality firefighting experiential system of claim 1, wherein the controller is composed in an extinguisher type, and comprises:
an extinguisher body;
a nozzle part coupled to an upper part of the extinguisher body to shoot content to the picture for each virtual fire situation, and composed of a marker configured to guide the auxiliary camera to trace the position and direction of the controller, and a motion sensor configured to sense a motion of the controller and deliver a sensed result to the MCU; and
a shoot operation part composed of a barometer configured to indicate a virtual atmospheric pressure state, a driving unit controlled by the MCU and configured to move a needle of the barometer, a shooting lever configured to control a shoot of the content through the nozzle part, a safety pin configured to block manipulation of the shooting lever, a safety pin sensor configured to sense whether the safety pin is pinned and a manipulation state of the shooting lever and to deliver a sensed result and the manipulation state to the MCU, a communication means configured to communicate with the control device through wired or wireless communication, and the MCU configured to deliver input values from the motion sensor and the safety pin sensor to the control device 500.

5. The virtual reality firefighting experiential system of claim 1, wherein correction of the controller is performed by matching up a preset reference direction, a recognition direction recognized by the control device, and an actual direction of the controller with each other, and
the matching up is performed with any one of a scheme for resetting, in a state where the direction of the controller is matched up with the preset reference direction, to a state where the reference direction, recognition direction, and actual direction are matched up with each other by manipulating a button of the controller,
a scheme for resetting to a state where reference direction, recognition direction, and actual direction are matched up with each other according to manipulation of the reset button for correcting the initial direction and position of the controller at a time of holding the controller, and
a scheme for guiding the controller to face the reference direction through a user's guide at a time of starting each step on a program installed in the control device, and then resetting to a state where the reference direction, recognition direction, and actual direction are matched up.
